(19) United States
(12) Patent Application Publication
(10) Pub. No.: US 2022/0175508 A1
(43) Pub. Date: Jun. 9, 2022

(54) MALE CANINE COMPANION

(71) Applicant: Stacy Alexis NOLAND, Tamarac, FL (US)

(72) Inventor: Stacy Alexis NOLAND, Tamarac, FL (US)

(21) Appl. No.: 17/538,095

(22) Filed: Nov. 30, 2021

Related U.S. Application Data
(60) Provisional application No. 63/120,898, filed on Dec. 3, 2020.

(51) Int. Cl. A61D 19/02; A01K 15/02; A61H 19/00

(52) U.S. Cl. CPC A61D 19/021; A61H 2203/03; A61H 19/32; A01K 15/025

(57) ABSTRACT

A doll shaped as a female canine comprising a body coupled to a plurality of adjustable limbs and having a rear hole, a tubular insert that is removable and sterilizable, wherein the rear hole is a cylindrical hollow portion designed as a tubular channel to receive the tubular insert with a plastic lining that collects the semen flow into the hollow body of the tubular insert and after using the tubular insert is removed and disinfected for the next use.

### FIELD OF THE INVENTION

The present invention relates to a female canine-shaped doll developed to enable the sexual satisfaction of male dogs hygienically and harmlessly.

### BACKGROUND

It has been evidently demonstrated that pet animals such as dogs, need social and sexual experience in order to know and develop a healthy process of mating. Male canines frequently present sexual needs that if not satisfied through mating with a female, could generate excessive tension and diseases such as depression. In these periods, the lack of mating makes the male canines “mate” with sofas, cushions stuffed animals and other objects thereby damaging the objects further causing abnormal mounting orientation in the male animals and apparently the brain centers that mediate sexual behavior are not completely activated.

Further, alternative procedures adopted nowadays by the male animals do not make them ejaculate frequently, leaving them uneasy and depressive and also circumventing the need for castration, which may lead to lower virility in the male animals.

Thus, to overcome the above drawbacks, there is a need for a device that provides complete and total satisfaction for the male canine species in a healthy manner.

### OBJECT OF THE INVENTION

The primary object of the present invention is to provide an aiding apparatus, i.e. a female canine doll that enables sexual intercourse replicating a natural experience for the male canine species.

Another object of the present invention is to enable the use of the device in various adjustments of height according to the size of the animal that shall use it.

Yet another object of the present invention is to provide the device as an alternative form of birth control for animals.

### SUMMARY

A sexual aiding apparatus for a male canine comprising: a first component designed as a tubular hole, a second component designed as a tubular insert, wherein the first component is designed to receive the second component to engage in a sexual act.

A method for aiding a male canine during a sexual act comprises: placing a second component into a first component, receiving semen in the second component through the first component, removing the second component from the first component, and sterilizing the first component and the second component.

A doll shaped as a female canine comprising: a head portion, a body portion coupled to a plurality of adjustable limbs and an opening at the rear side of the portion, wherein the head portion and the body portion are connected through a neck portion, and wherein the opening at the rear side is designed as a tubular hole to receive a tubular insert, wherein a male animal inserts its penis in the tubular insert and ejaculates.

Other contemplated embodiments can include objects, features, aspects, and advantages in addition to or in place of those mentioned above. These objects, features, aspects, and advantages of the embodiments will become more apparent from the following detailed description, along with the accompanying drawings.

### BRIEF DESCRIPTION OF THE DRAWINGS

FIG. 1A is a perspective view of the doll, in accordance with an example embodiment;

FIG. 1B is a right side view of the doll, in accordance with an example embodiment;

FIG. 1C is a left side view of the doll, in accordance with an example embodiment;

FIG. 1D is a rear view of the doll, in accordance with an example embodiment;

FIG. 2A illustrates the doll with a tubular hole designed to receive a tubular insert through the opening, in accordance with an embodiment;

FIG. 2B illustrates the doll with a tubular hole designed to receive a tubular insert through the opening operated by a motor, in accordance with another embodiment;

FIG. 3A illustrates a tubular insert, in accordance with one embodiment;

FIG. 3B illustrates a tubular insert, in accordance with another embodiment;

FIG. 4 illustrates the adjustment assembly embodied in each limb of the doll, in accordance with one embodiment;

FIG. 5A illustrates the doll in a laying down position, in accordance with one embodiment;

FIG. 5B illustrates the doll in a back down position, in accordance with one embodiment;

FIG. 5C illustrates the doll in a standing up or raised position, in accordance with one embodiment;

FIG. 5D illustrates the doll in a front down position, in accordance with one embodiment;

FIG. 6A shows a perspective view of a mould overlay of the doll, in accordance with an example embodiment;

FIG. 6B shows a rear view of a mould overlay of the doll, in accordance with an example embodiment; and

FIG. 6C shows a side view of a doll with fur, in accordance with an example embodiment.

The drawings referred to in this description are not to be understood as being drawn to scale except if specifically noted, and such drawings are only exemplary in nature.

### DETAILED DESCRIPTION OF EXEMPLARY EMBODIMENTS

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

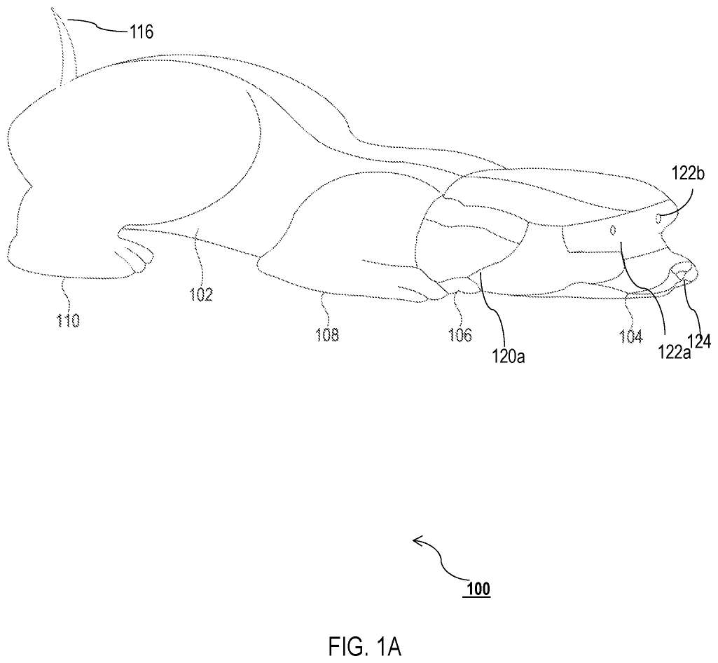

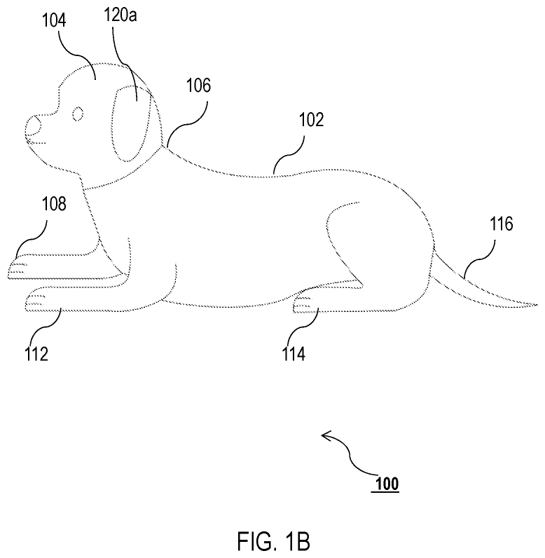

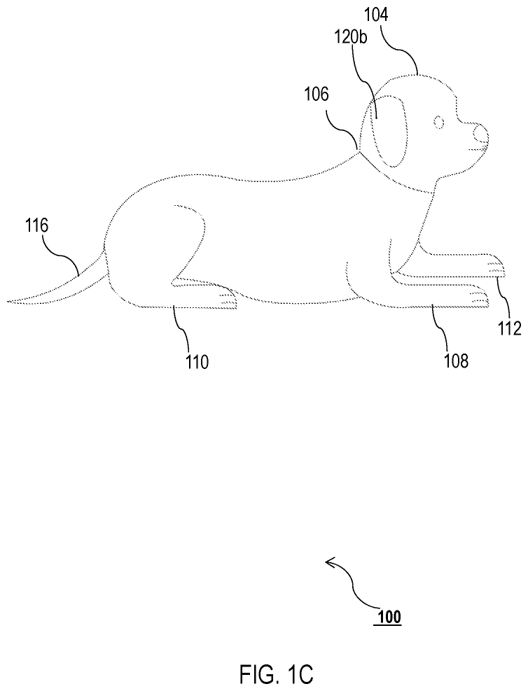

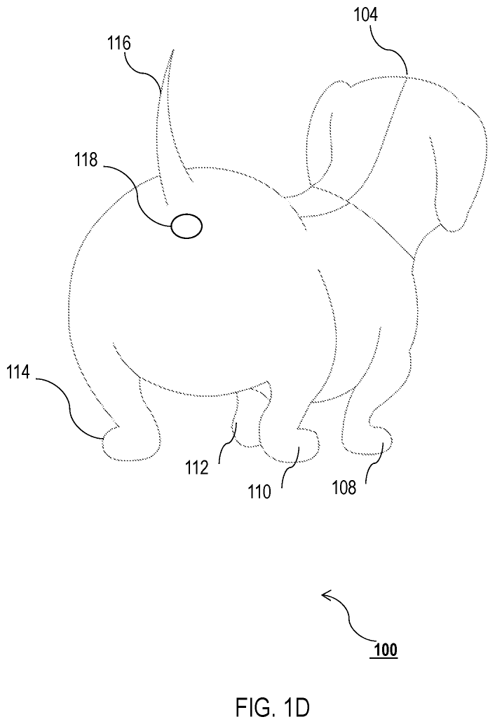

FIGS. 1A-1D illustrate different views of the doll 100, in accordance with an example embodiment. FIG. 1A is a perspective view of the doll 100, in accordance with an example embodiment. FIG. 1B is a right side view of the doll 100, in accordance with an example embodiment. FIG. 1C is a left side view of the doll 100, in accordance with an example embodiment. FIG. 1D is a rear view of the doll 100, in accordance with an example embodiment.

The doll 100 is shaped as a female canine comprising of a central cavity forming the body portion 102 with protrusions extending at lower portions of the central cavity forming the limbs 108, 110, 112, 114 of the body. The central cavity of the body includes a protrusion extending forward forming a head portion 104, connecting the head portion and the cavity portion of the body includes an extension forming the neck of the doll 100. The head portion 104 through the neck portion 106 is movably or immovably connected to the body portion 102 of the doll 100. The movable adjustment mechanisms may include battery/motor-powered adjustable flanges, or magnets, or the like.

According to an embodiment, the limb portions include a right front leg portion 108 extending from the right front corner of the body cavity of the doll 100, a left front leg portion 112 extending from the right front corner of the body cavity of the doll 100, a right rear leg portion 110 extending from the right rear corner of the body cavity of the doll 100, and a left rear leg portion 114 extending from the left rear corner of the body cavity of the doll 100. The limbs 108, 110, 112, 114 are adjustable to bend in various positions as per the height of the male animal intended to mount the doll 100. Further, a protrusion extending at the rear surface of the body portion 102 is designed to form a tail portion 116 of the doll 100.

According to an embodiment, all the components, the head portion 104, the limbs 108, 110, 112, 114 and the tail 116 are connected thereto in a movable manner to the central body portion 102. In an exemplary scenario, the components, the head 104, the body 102, the limbs 108, 110, 112, 114 and the tail 116, are each made by the injection moulding process. Wherein, the head portion 102 is divided transversely to include the formations of the eyes 122a, 122b, the mouth 124, the nose 126, and the ears 120a, 120b.

Further, as illustrated in FIG. 1D, the rear side of the doll 100, comprises an opening 118 designed as a cylindrical hollow portion enabling a male animal to mount the rear section engage in mating and address the sexual needs of the male animal.

According to an embodiment, the body of the doll 100 may be made of nontoxic, elastomeric materials such as a hard mould silicone material. The outer surface of the mould may be covered with fabric such as fur, nylons, polypropylenes and polyesters, natural fibers and the like. The fabric may be removably placed, wherein the outer fabric may be removed to wash and clean the doll 100. The doll 100 can include variations in sizes and shapes depending on specific needs of the male animal. Some components of the exterior material may be made of a sheet of material having anti-skid or anti-slip properties.

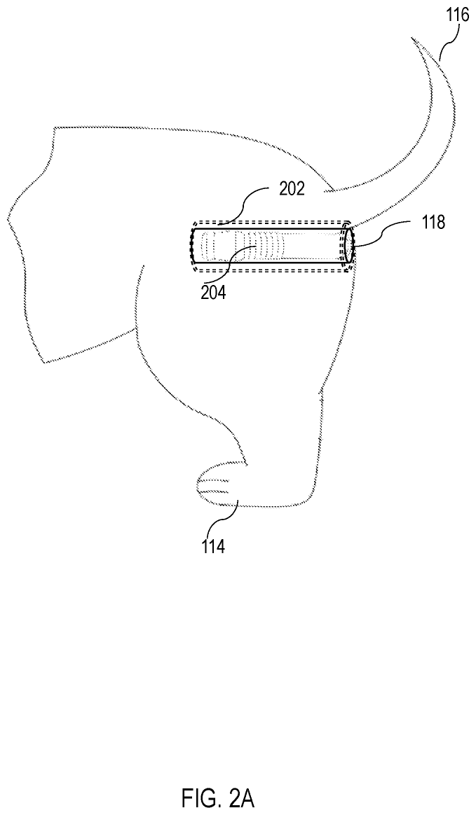

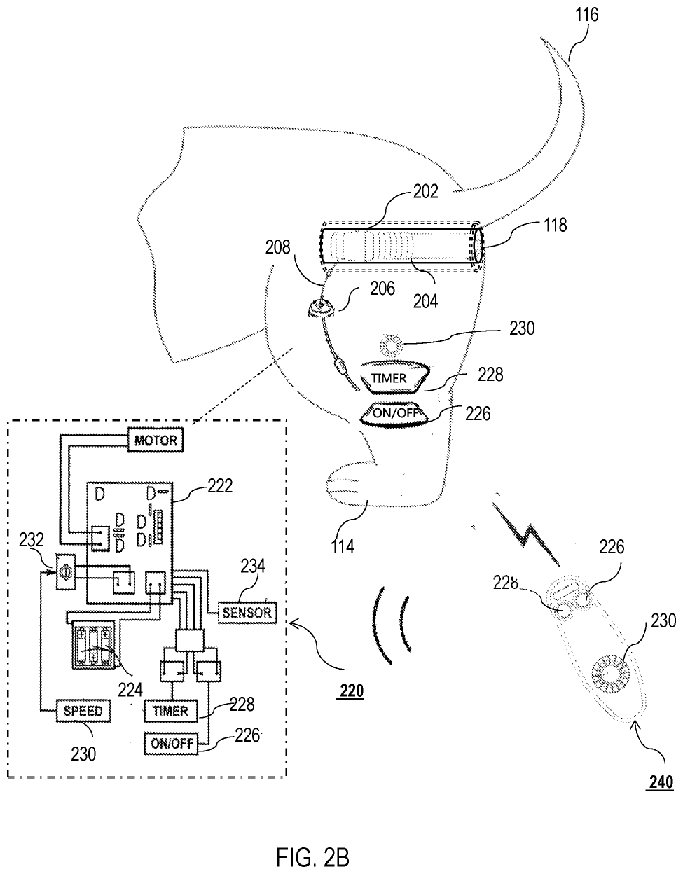

FIG. 2A illustrates the doll 100 with a tubular hole 202 designed to receive a tubular insert 204 through the opening 118, in accordance with an embodiment. The tubular hole 202 is a cylindrical channel that serves as a vaginal passageway and the tubular insert 204 is designed to comfortably lock in the passageway of the tubular hole 202 and serves as the vagina of the doll 100.

The opening 118 may be different sizes or shapes, to allow for further adjustability of the separation force between tubular hole 202 and the tubular insert 204 according to the shape and size of the male animal mounting on the doll 100. The tubular hole 202 and the tubular insert 204 are designed with created enough separability and adjustability force to replicate the rhythmic motions of the sexual intercourse. The magnitude of the necessary separation force will depend on the difference between the cross-sectional dimension of the tubular hole 202 and the tubular insert 204, the greater the difference between the two dimensions the larger the separation force and the lesser the difference between the two dimensions the lesser the separation force. Thus, the tubular hole 202 and the tubular insert 204 are made of deformable material, wherein the structure of the tubular hole 202 and the tubular insert 204 expand and contract in line with the motion of the male animal.

For example, a deformable material, may include thermoplastic elastomers such as thermoplastic rubber (TPR), natural rubber, synthetic rubber, mixtures thereof, and the like.

In use, a male animal mounts the doll 100 in a physical act, where the male animal inserts its penis in the tubular insert 204 and ejaculates without causing any harm. The tubular hole 202 acting as a channel and receives the semen released from the male animal during intercourse. The collected semen in the tubular insert 204 can then be discarded or stored for the means of artificial insemination.

After use, the tubular hole 202 can be cleaned or washed with bactericide soap and water as necessary and the tubular insert 204 is removable and sterilizable. Further, doll 100 is cleaned and sterilized for the next use. This method eliminates the contamination risks by the proliferation of fungus and bacteria and does not include any metal part that can hurt the animal, and is not harmful to the animal during its use.

FIG. 2B illustrates the doll 100 with a tubular hole 202 designed to receive a tubular insert 204 through the opening 118 operated by a motor 206, in accordance with another embodiment. The tubular hole 202 is a cylindrical channel serves that serves as the vaginal passageway and the tubular insert 204 is designed to comfortably lock in the passageway of the tubular hole and serves as the vagina of the doll 100. The rear leg 114 of the doll 100 includes a drive motor/motor 206 connected to a shaft 208 that is in contact with a tubular insert 204.

When the drive motor 206 is activated using the drive motor activation means, it rotates or vibrates the shaft causing external stimuli for the tubular insert 204. The drive motor 206 may also be configured to operate at varying speeds of operation. The electronic control circuit diagram 220 (overlay diagram) of the activation means includes a circuit 222 is powered by the batteries 224 and functions as means for powering (i.e., controlling) the drive motor 206 according to input from a user via an On/Off button 226, a timer button 228, and a speed-controlling knob/button 230 connected to a variable resistor 232. In other words, the circuit 220 functions as means for powering the motor 206 to rotate or vibrate the shaft causing external stimuli for the tubular insert 204. The input to the circuit 222 is provided by a sensor 234 that functions as means for detecting a male animal in close proximity to the doll 100 to automatically turn the circuit 222 on and power the motor 206.

One of ordinary skill in the art may use well-known components and circuit design techniques for an electronic control circuit that controls the motor 206 as desired. The circuit 222 is adapted to function as means for enabling a user to select a running time after which the electric circuit automatically turns the electric motor off. After turning the circuit 222 on with the On/Off button 226, the user depresses the timer-button 228 a selected number of times to specify the time for the motor to function. The on/off-button 226 and the timer button 228 are disposed on the surface of the doll 100 or a remote control device 240, for example, the on/off button 226 may be disposed on the rear leg 114 of the doll 100 and is connected through a shaft 208 to the drive motor 206.

Further, the speed controlling knob or button 230 is disposed on the surface of the doll 100 or a remote control device 240, The circuit 30 is also adapted to function as means for enabling a user to select a speed at which the electric motor operates. The user turns the speed-controlling knob or buttons 230 and the circuit 222 powers the motor 206 accordingly. In addition, the circuit 222 is adapted to function as means for automatically reversing the direction of the motor 206 (i.e., reversing motor direction) at various times. One of ordinary skill may use well-known circuit elements and circuit design techniques to accomplish that operational characteristic. Operating the motor 206 at various speeds causes the tubular hole 202 and the tubular insert 204 to move in a manner provocative to the male animal and deliver a pleasurable sexual experience.

In some embodiments, the doll 100 is operated manually. In other embodiments the doll 100 is operated through the remote control 240. In still other embodiments, the doll 100 may be manually and remotely operated as illustrated in FIG. 2B.

Further, in alternate embodiments, the doll 100 is made visually appealing and includes olfactory sensors to detect the proximity of the male animal and release female pheromones, wherein the pheromones may be artificially collected and induced in the tubular hole 202 of the doll 100.

In use, a male animal mounts the doll 100 in a physical act, wherein the dog inserts his penis, in the tubular insert 204 and ejaculates without causing any harm. The owner of the male animal may manually or remotely activate the motor 206 powering up the motor to cause momentum and generate rhythmic motions or may automatically power up the motor 206 through the sensor 232. The tubular hole 202 acting as a channel starts to vibrate with the tubular insert and receives the semen released from the dog during intercourse. The collected semen in the tubular insert 204 can then be discarded or stored for the means of artificial insemination.

After use, the tubular hole 202 can be cleaned or washed with bactericide soap and water as necessary and the tubular insert 204 is removable and sterilizable. Further, doll 100 is cleaned and sterilized for the next use. This method eliminates the contamination risks by the proliferation of fungus and bacteria and does not include any metal part that can hurt the animal, and is not harmful to the animal during its use.

According to an embodiment, the tubular insert 204 is designed to securely engage with the tubular hole 202, wherein the tubular insert 204 is snapped or tractably secured to the tubular hole 202. Before use, the owner of the male animal locks the tubular insert 204 by rotating the tube or by snapping the tube to the receptacle of the tubular hole 202. After use, the owner of the male animal disengages the tubular insert 204 by rotating the tube in the opposite direction to unlock or by depressing the tubular insert 204.

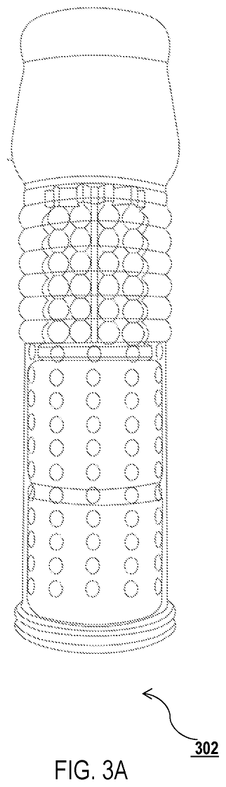

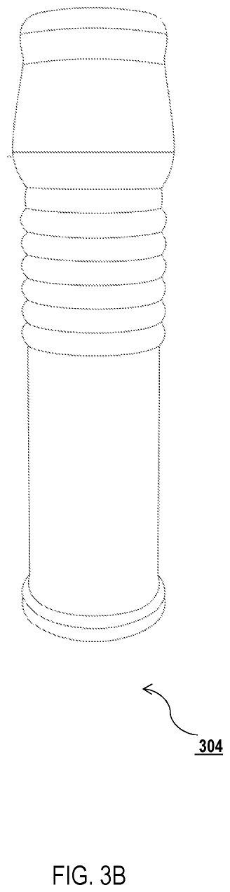

FIG. 3A-3B illustrate the tubular inserts 302 & 304, in accordance with one or more embodiments. The tubular insert 302 & 304 is substantially a cylindrical portion having a closed distal end, an open proximal end, and a hollow interior section. The cylindrical portion of the tubular inserts 302 & 304 with closed distalis designed to provide supporting and stabilizing means to prevent the tubular insert tubular inserts 302 & 304 from unintentionally moving during the act. It is preferred that the shape of the tubular insert 302 & 304 does not present any sharp corners or surfaces but instead is shaped to present rounded or curved surfaces to minimize any discomfort during insertion, in-use, and removal of the tubular insert 302 & 304. Accordingly, the edges of the proximal end are rounded and the proximal end of the tubular insert 302 & 304 allows for easier removal. Furthermore, the shape of the tubular insert in the in-use model is designed to minimize irritation and alleviate constant pressure. The tubular insert 302 & 304, which shall be in direct contact with the genitals of the dog, can be removed and sterilized with boiling water or cleaned with bactericide soap after its use.

In another embodiment, a removal member may be attached to the tubular insert 302 & 304. The removal member may be anything known to one skilled in the art such as plastic lining to allow a user to remove the tubular insert 302 & 304 and may also include an absorbent material. In some embodiments, the tubular inserts 302 & 304 may include beads and ribbed portions on the exterior surface to enhance pleasure. In an embodiment, the interior-facing circumferential surface and/or surfaces of the tubular inserts 302 & 304 may include padding, lubrication, gels, and/or fragrances, any one or more designed or intended to enhance the pleasure and/or the safety of the male animal during the physical act. The tubular inserts 302 & 304 size is adjustable to accommodate various animal penis sizes.

According to an embodiment, the tubular inserts 302 & 304 are made of a flexible, soft non-toxic, deformable material such as thermoplastic rubber (TPR), natural rubber, synthetic rubber, mixtures thereof, and the like.

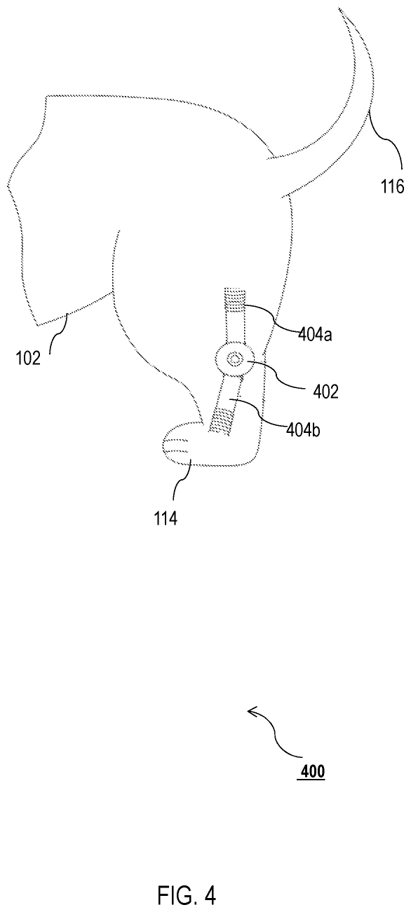

FIG. 4 illustrates the adjustment assembly 400 embodied in each limb 108, 110, 112, 114 of the doll 100, in accordance with an embodiment. Each of the limbs 108, 110, 112, 114 attached to the body portion 102 may include an adjustable means that can be angularly adjusted to different positions. According to an embodiment, the adjustable assembly 400 comprising a central circular base 402 including one or more plates engaged to a drive wheel having a substantially longitudinal axis. The central circular base 402 is attached thereto two extension arms angular placed, wherein the first arm 404a extends upwards and the second arm 404b extends downwards. The arms 404a, 404b are fit snuggly into the alignment indentations (such as jaws) of the central base 402. Further, the arms 404a, 404b and the central base 402 may be additionally secured using screws, bolts and the like.

The arms 404a, 404b are designed to include hinges or flanges which cause enough displacement for the arms 404a, 404b to bend in a radial fashion from the center portion of the doll 100, adding stability and functionality.

Each limb 108, 110, 112, 114 can be manually swung around an axis to assume the desired position. The frictional contact of the rotatable means of the central base 402 and the arms 404a, 404b disposed of at the limb ensures that the limb 108, 110, 112, 114 is capable of being adjusted and retained in any desired position. The limb 108, 110, 112, 114 can be returned to its normal lowered position, or any intermediate position, by suitable manual manipulation of the limb (e.g. pressing or depressing the central region and the limb in motion) to adjust the height of the doll 100 according to the size of the animal that shall use it. Alternatively, any variation in the adjustable assembly can be provided in a suitable manner.

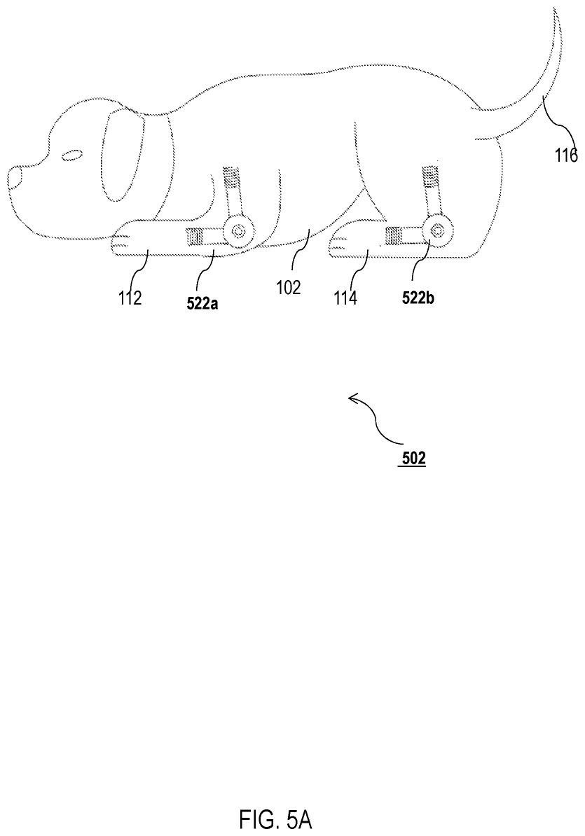

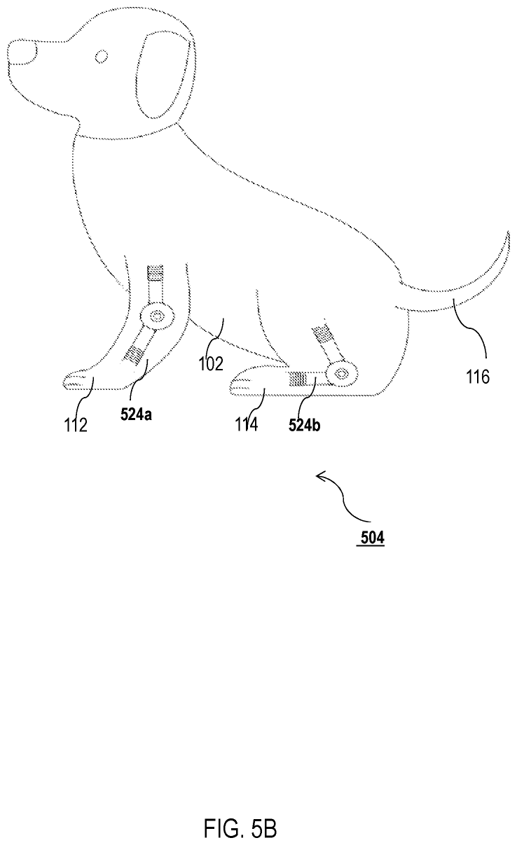

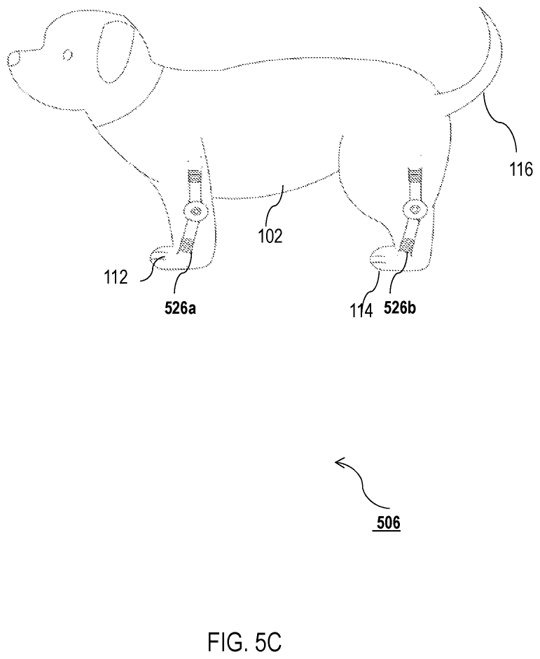

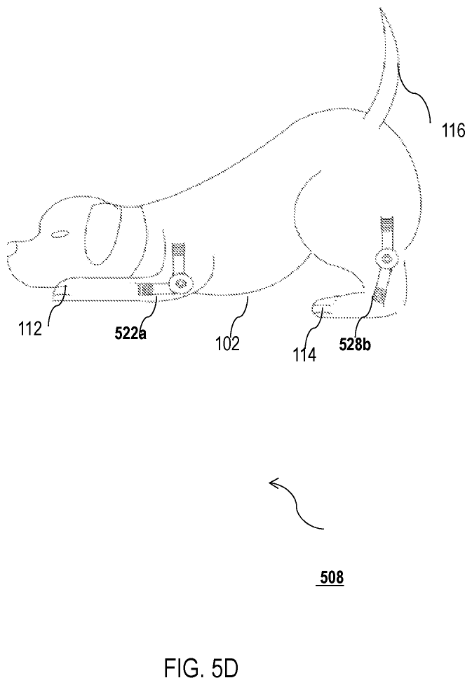

FIGS. 5A-5D illustrate the various adjustments of positions of the doll 100, in accordance with an embodiment. FIG. 5A illustrates the doll 100 in a laying down position 502, in this position the front adjustable assembly 522a and the back adjustable assembly 522b disposed at the front limbs 108, 112 and the back limbs 110, 114 are orientated in the first axis, where the two arms of the adjustable assembly 522a, 522b are at an acute angle with respect to each other.

FIG. 5B illustrates the doll 100 in a back down position 504, in this position the front adjustable assembly 524a disposed at the front limbs 108, 112 are oriented in the second axis, where the two arms of the adjustable assembly 524a are at an obtuse angle with respect to each other and the back adjustable assembly 524b disposed at back limbs 110, 114 are oriented in the first axis, where the two arms of the adjustable assembly 524b are at an acute angle with respect to each other.

FIG. 5C illustrates the doll 100 in a standing up or raised position 506 in this position the front adjustable assembly 526a and the back adjustable assembly 526b disposed at the front limbs 108, 112 and the back limbs 110, 114 are orientated in the second axis, wherein the two arms of the adjustable assembly 526a, 526b are at an obtuse angle with respect to each other.

FIG. 5D illustrates the doll in a front down position 508, in this position the front adjustable assembly 528a disposed at the front limbs 108, 112 are oriented in the first axis, where the two arms of the adjustable assembly 524a are at an acute angle with respect to each other and the back adjustable assembly 524b disposed at back limbs 110, 114 are oriented in the second axis, where the two arms of the adjustable assembly 524b are at an obtuse angle with respect to each other.

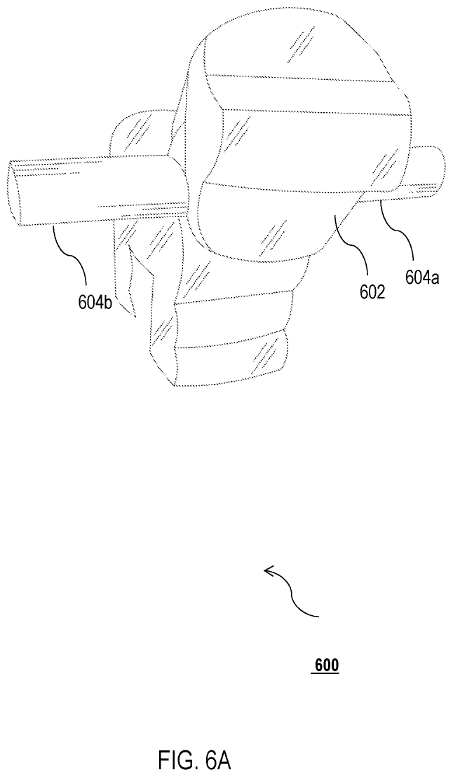

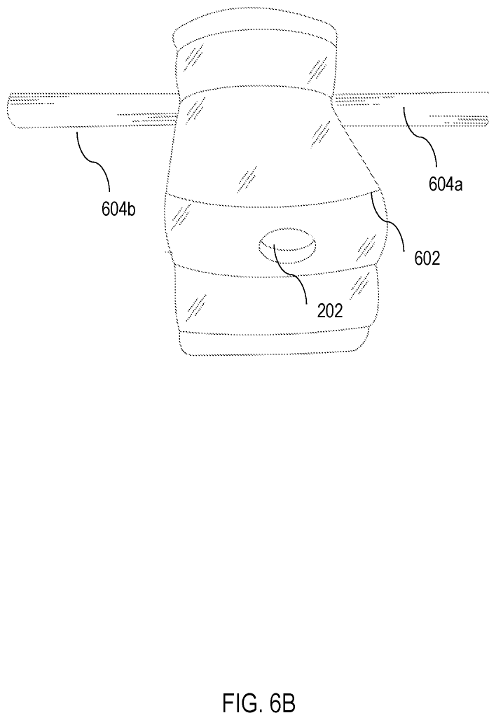

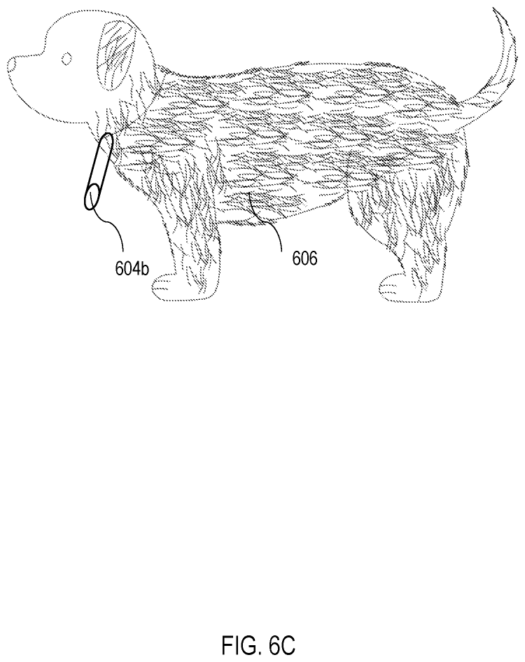

FIGS. 6A-6C illustrate the various process stages of the doll 600 according to another embodiment. FIGS. 6A and 6B shows a mould overlay view of the doll 600, in accordance with an example embodiment.

At the initial step of the process, an overlay mould 602 of silicon is built to replicate the structure of a female canine. The doll's silicone is moulded with tubular hole 202, and to embed the adjustable assembly 400, and/or the drive motor 206 inside the doll 600. The mould 602 prepared is physically similar to the target overlay model of the female canine. The doll's silicone may be dyed with different colors for each segment and also include outlines to provide definitions to specific parts of the doll 600.

According to an embodiment, the doll 600 may also include handles 604a, 604b disposed at either side of the neck. The handles 604a, 604b are designed to provide extra support and could possibly be weighted so as to minimize shifting, sliding, and/or tipping over the doll 600 by the male animal during the act. The handles may be 604a, 604b covered with anti-skid materials.

FIG. 6C shows a doll 600 covered with fur 606. As the second step of the process, the outer surface of the mould is covered with fur 606 formed by using an inner cloth-like sheet or foam with outwardly extending fibers. The fur 606 may be attached to mould 602 using glue, velcro, hooks and the like.

The apparatus, is designed to inhibit the mating of the pets and avoid pregnancy and consequently can be developed in various configurations and shapes for furred animals such as dogs, foxes, wolves, and other species of similar type.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such are intended to cover the application and\or implementation without departing from the spirit or scope of the claims.

What is claimed:

1. A sexual apparatus for male canine comprising:
a first component designed as a tubular hole;
a second component designed as a tubular insert;
wherein the first component is designed to receive the second component to engage in a sexual act.

2. The apparatus of claim 1, wherein the first component is disposed at the rear side of a female canine doll.

3. The apparatus of claim 1, wherein the first component is designed as a vaginal passageway of the female canine doll.

4. The apparatus of claim 1, wherein the second component is designed as a vagina of the female canine doll.

5. The apparatus of claim 1, wherein the first component can be cleaned or washed with bactericide soap and water.

6. The apparatus of claim 1, wherein the second component is removable and sterilizable.

7. The apparatus of claim 1, wherein the first component and the second component are motor operated.

8. The apparatus of claim 1, wherein the second component collects the semen released by a male canine during the sexual act.

9. A method for aiding a male canine during a sexual act comprises:
placing a second component into a second component;
receiving semen in the second component through the first component;
removing the second component from the first component; and
sterilizing the first component and the second component.

10. The method of claim 9, wherein the first component is designed as a tubular hole.

11. The method of claim 9, wherein the second component is designed as a tubular insert.

12. The method of claim 9, wherein the first component is disposed at the rear side of a female canine doll.

13. The method of claim 9, wherein the first component is designed as a vaginal passageway of the female canine doll.

14. The method of claim 9, wherein the second component is designed as a vagina of the female canine doll.

15. The method of claim 9, wherein the first component can be cleaned or washed with bactericide soap and water.

16. The method of claim 9, wherein the first component and the second component are motor operated.

17. A doll shaped as a female canine comprising:
a head portion;
a body portion coupled to a plurality of adjustable limbs and an opening at the rear side of the portion;
wherein the head portion and body portion are connected through a neck portion; and
wherein the opening at the rear side is designed as a tubular hole to receive a tubular insert, wherein a male animal inserts its penis in the tubular insert and ejaculates.

18. The doll of claim 17, wherein the tubular hole is designed as a vaginal passageway and the tubular insert is designed as a vagina of the female canine doll.

19. The doll of claim 17, wherein the head portion through the neck portion is movably or immovably connected to the body portion.

20. The doll of claim 17, wherein the tubular hole and the tubular insert are motor operated.
